(19) United States
(12) Patent Application Publication
(10) Pub. No.: US 2006/0193072 A1
(43) Pub. Date: Aug. 31, 2006

(54) Information recording apparatus and method, magnetic disk producing apparatus and method, and magnetic disk

(75) Inventor: Shinichi Nakao, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/354,103

(22) Filed: Feb. 15, 2006

(30) Foreign Application Priority Data
Feb. 18, 2005 (JP) 2005-042911

(51) Int. Cl. G11B 5/09; G11B 5/596

(52) U.S. Cl. 360/48; 360/51; 360/77.08

(57) ABSTRACT

Address information/ID information is recorded to a magnetic disk whose recording tracks are formed of lands. There is provided an information recording apparatus for recording address information/ID information to an address information/ID information area of a magnetic disk having formed, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the data area, clock area, servo area and address information/ID information area being formed convex and each recording track having a fixed-period control signal recorded therein, the apparatus including: a detector for detecting a unique area; a reader for reading the fixed-period control signal recorded in the clock area; an information generator for generating unique address information/ID information; and a recorder for recording, when the detector has detected a unique area, the unique address information/ID information generated by the information generator to an address information/ID information area in a sector to which the detected unique area also belongs on the basis of the control signal read by the reader.

### CROSS REFERENCES TO RELATED APPLICATIONS

The present invention contains subject matter related to Japanese Patent Application JP 2005-042911 filed in the Japanese Patent Office on Feb. 18, 2005, the entire content of which is incorporated herein by reference.

### BACKGROUND OF THE INVENTION

1. Field of the Invention

The present invention relates to an information recording apparatus and method, for recording address information/ID information to a magnetic disk, a magnetic disk producing apparatus and method, and a magnetic disk.

2. Description of the Related Art

The magnetic recording/reproducing apparatus has so far been required to have an increased recording capacity. The current tendency of this field is to design a magnetic recording/reproducing apparatus capable of recording data with a higher density. As the typical magnetic storage unit, hard disk drives of more than 1 Gbits/in² in surface recording density have already been produced on a commercial basis.

Note that the hard disk is a horizontally flat disk having recording tracks formed concentrically in a direction from the central hole toward the outer radius and of which adjacent ones form together a zone in which they are not physically independent of each other but contiguous to each other. In such a hard disk, the radial density of the recording tacks, that is, the track pitch, influences the signal-to-noise ratio (S/N ratio) of the reproduced signal because of the problems which will be explained below:

1. Record Head Width Ww in Disk-Radial Direction

When data is recorded by a record head, the larger the width Ww of the record head, the wider the recording mark will be formed. Also, the fringe field of the record head causes fringing in the radial direction of the hard disk so that the recording mark will actually have a width larger than Ww. Therefore, the width of the recording mark includes a part (as wide as the record head) formed by the record head and a part formed due to the fringing. No correct reproduced signal call be obtained from the part formed due to the fringing.

Therefore, when the record head width Ww is as large as the recording track width W, an extra signal will be recorded to adjacent recording tracks and the fringing spread to the recording marks formed on the tracks. If the fringing has thus spread to the recording marks, the S/N ratio of the reproduced signal will be deteriorated when the read head detects the fringe field. Therefore, the record head width Ww should be smaller than the recording track width W (Ww<W).

2. Read Head Width Wr in Disk-Radial Direction

On the other hand, to obtain a high-sensitivity reproduced signal from the fringe field of the recording mark, it is necessary to detect no fringe field from the part formed due to the fringing at the time of recording and design the read head width Wr equal to or smaller than the recording mark width. Especially, the read head should be designed to have a width which can cope with the fact that the center of the recording track cannot always be traced because of a servo deviation occurring during data reading. On the other hand, the smaller the read head width Wr, the smaller the obtainable reproduced signal will be. So, the read head width Wr may not be designed smaller because the reproduced signal will have S/N ratio accordingly deteriorated.

Therefore, as will be seen from the description of the problems 1 and 2, the relation among the read head width Wr, record head width Ww and recording track width W will be as follows;
Wr<Ww<W
So, a recording mark cannot be formed over the recording track width W while reading cannot be made from a formed recording mark as a whole.

On this account, a technique called “DTR (Discrete Track Recording)” has been proposed for a higher density of data recording to a hard disk. The DTR technique is to solve the aforementioned problems of the recording track pitch. More particularly, in a hard disk, adjacent recording tracks are made independent of each other by forming, between them, a physical recess to such a depth and shape that the fringe field from the recess will not reach the read head or that the read head will not detect the fringe field.

In the hard disk having the recess formed between adjacent recording tracks with the DTR technique, since no consideration may be given to the fringing, so the record head width Ww may be designed larger than the recording track (land) width W and the recording mark may be formed over the land width. Thus, the above problem 1 can be solved. Also, since no consideration may be given to the part formed due to the fringing, the read head width Wr may be designed larger than the land width W. Even with a servo deviation, reading can be made from over the land width W. Thus, the above problem 2 can be solved.

That is to say, the readable recording mark width depends upon the land (recording mark) width W, and the DTR technique is not used. Namely, since the recording mark can be formed wider than the recording mark formed in a hard disk having no recess formed between adjacent recording tracks, so the S/N ratio can be increased in relation to the recording track pitch.

Note here that the hard disk is formed from a magnetic material and information such as servo information is also recorded with magnetic signals of S and N polarities. In the past, a servo signal and disk position signal have been recorded with a jig or the like before the hard disk is assembled into each hard disk drive.

In a hard disk adopting the DTR technique, since the recording tracks are formed as convexities when the hard disk is being produced, so it is necessary to record servo information along the recording tracks. To this end, the Applicant of the present invention proposed a method disclosed in the Japanese Patent No. 2863190 (will be referred to as “Patent Document 1” hereunder). The Patent Document 1 discloses a method of recording a servo signal by recording a repetition signal to a hard disk through magnetization with an external alternating magnetic field.

### SUMMARY OF THE INVENTION

Note that as in the conventional hard disks, it is necessary to record address information and ID information (information intended to obtain information on the hard disk angle, etc.) to even a hard disk formed with the DTR technique.

It is therefore desirable to overcome the above-mentioned drawbacks of the related art by providing an information recording apparatus and method, for recording address information/ID information to a magnetic disk having a recess formed between adjacent recording tracks thereon with the DTR technique, a magnetic disk producing apparatus and method, for producing a magnetic disk having address information/ID information recorded therein, and a magnetic disk having address information/ID information recorded therein.

According to the present invention, there is provided an information recording apparatus for recording address information/ID information to an address information/ID information area of a magnetic disk having formed, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the data area, clock area, servo area and address information/ID information area being formed convex and each recording track having a fixed-period control signal recorded therein, the apparatus including a detecting means for detecting a unique area, a reading means for reading the fixed-period control signal recorded in the clock area, an information generating means for generating unique address information/ID information, and a recording means for recording, when the detecting means has detected a unique area, the unique address information/ID information generated by the information generating means to an address information/ID information area in a sector to which the detected unique area also belongs on the basis of the control signal read by the reading means.

According to the present invention, there is also provided an information recording method of recording address information/ID information to an address information/ID information area of a magnetic disk having formed therein, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the data area, clock area, servo area and address information/ID information area being formed convex and each recording track having a fixed-period control signal recorded therein, wherein when a unique area has been detected, unique address information/ID information generated by an address information/ID information generating means is recorded, with a delay of a fixed length of time, to an address information/ID information area in a sector to which the detected unique area also belongs on the basis of the fixed-period control signal recorded in the clock area.

According to the present invention, there is also provided a magnetic disk producing apparatus for producing a magnetic disk having formed therein, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the apparatus including an address information/ID information generating means for generating unique address information/ID information, and an etching means for appropriately changing the shape of the address information/ID information area on the basis of address information/ID information generated by the address information/ID information generating means and etching the address information/ID information area.

According to the present invention, there is also provided a magnetic disk producing method of producing a magnetic disk having formed therein, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the method including the steps of recording unique address information/ID information to each address information/ID information area by appropriately changing the address information/ID information area on the basis of address information/ID information generated by an address information/ID information generating means and etching the address information/ID information area.

According to the present invention, there is also provided a magnetic disk having formed therein, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, wherein the data area, clock area, servo area and address information/ID information area are formed convex, the address information/ID information area has formed thereon a convexity and/or concavity having an appropriate predetermined shape on the basis of address information/ID information generated by an address information/ID information generating means for generating unique address information/ID information, and each address information/ID information area has unique address information/ID information recorded therein.

According to the present invention, it is possible to delay timing of recording address information/ID information by detecting a unique area on the recording track and read a servo signal from the servo area on the basis of a clock signal read from the clock area for the time of delay to control tracking of the head unit, and to record the address information/ID information, whose timing of recording has been delayed as above, to an address information/ID information area in a sector to which the detected unique area also belongs on the basis of the clock signal.

According to the present invention, address information/ID information may also be recorded to over the magnetic disk still in the production line before shipment of the magnetic disk from factory or may be recorded to each recording track each time a record start command is issued from a host computer when recording data to the magnetic disk after shipment of a hard disk drive having the magnetic disk assembled therein or after delivery from the production line. Especially with the latter manner of address information/ID information recording, the tact time can be reduced in mass production of the hard disk drive.

According to the present invention, the clock area, servo area and address information/ID information area may be positioned in any order and no special information is required for positioning such areas except for the unique area. Thus, since the format of a signal to be recorded to the magnetic disk may be approximate to that adopted in the IC installed in the existing magnetic disk playing system, so the existing IC can easily be appropriated.

According to the present invention, address information/ID information is formed in (recorded to) each address information/ID information area by etching or the like on the basis of the address information/ID information. Thus, since it is not necessary to record such address information/ID information in any separate step, so that the tact time can be reduced.

### BRIEF DESCRIPTION OF THE DRAWINGS

FIG. 1 schematically illustrates a magnetic disk as an embodiment of the present invention;

FIG. 2 is an illustration, enlarged in scale, of a part of the magnetic disk shown in FIG. 1;

FIG. 3 is a first sectional view, enlarged in scale, of a substantial part of the magnetic disk shown in FIG. 2;

FIG. 4 is a second sectional view, enlarged in scale, of the substantial part of the magnetic disk shown in FIG. 2;

FIG. 5 is a schematic block diagram of a first example of the apparatus for recording address information/ID information to the magnetic disk;

FIG. 6 is an illustration, enlarged in scale, of a part of the magnetic disk having information magnetically recorded thereto;

FIG. 7 is a schematic block diagram of a second example of the apparatus for recording address information/ID information to the magnetic disk;

FIG. 8 shows how record of address information/ID information is delayed;

FIG. 9 is a sectional view, enlarged in scale, of a part of the magnetic disk of which the address information/ID information area is etched; and

FIG. 10 illustrates a signal waveform obtained when the magnetic disk shown in FIG. 9 is played.

### DETAILED DESCRIPTION OF THE PREFERRED EMBODIMENTS

The present invention will be described in detail below concerning the embodiments thereof with reference to the accompanying drawings.

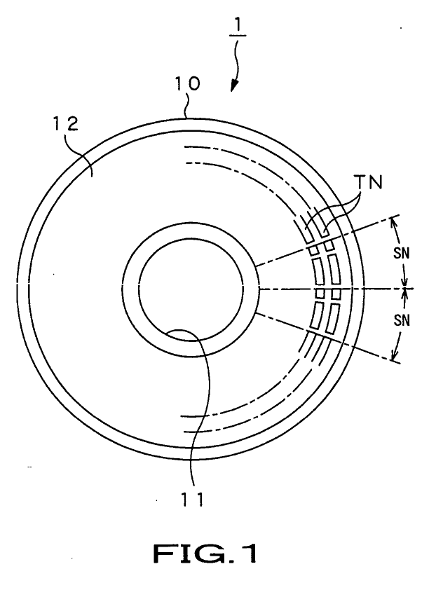

Referring now to FIG. 1, there is schematically illustrated a magnetic disk produced as an embodiment of the present invention by a magnetic disk producing method which is also an embodiment of the present invention. The magnetic disk is generally indicated with a reference numeral 1. According to this embodiment, the magnetic disk 1 includes a substrate 10 formed from aluminum to have a disk-like shape, for example. The substrate 10 has formed therein a central hole 11 around which there is provided a magnetic layer as a recording region 12. In the recording region 12, information/data is recorded to a plurality of recording tracks TN formed concentrically around the central hole 11 to provide tracking servo control information when the magnetic disk 1 is played.

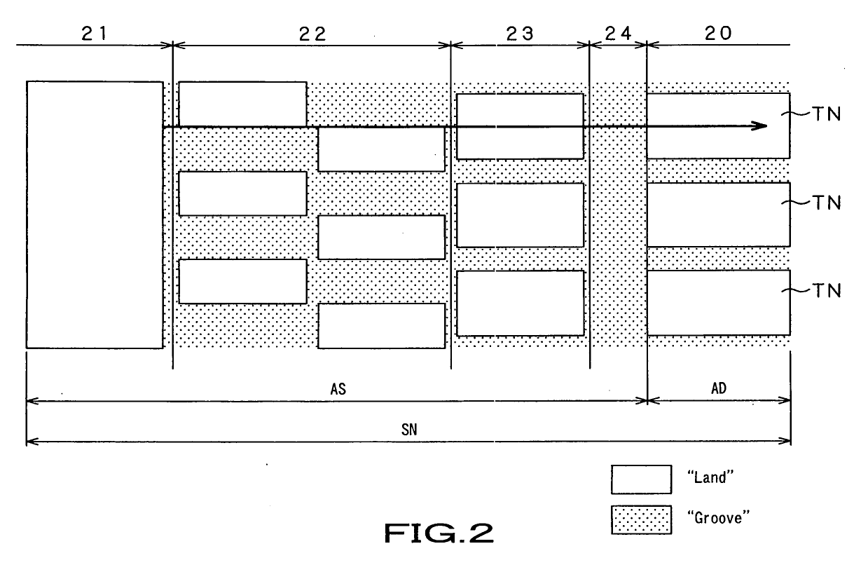

Each of sectors SN included in each of the recording tracks TN includes a recording pattern consisting of control information recording areas AS and data/information recording areas AD as shown in FIG. 2. Each of the data/information recording areas AD includes a partitioned data/information area 20 formed from flat truncated convexities (will be referred to as “land” hereunder) each extending along the recording tracks TN, projecting vertically from a hatched surface and having a magnetic layer provided thereon. Each of the control information recording areas AS includes an address data/ID information area 21 formed from a land extending perpendicularly to the recording tracks TN, projecting vertically from the hatched surface and having a magnetic layer provided thereon, and to which address information etc. are to be recorded, PES (Position Error Signal) area 22 formed from lands each extending along the recording tracks TN, projecting vertically from the hatched surface, and having a magnetic layer provided thereon, and to which a servo signal used to make tracking of a record/read head is to be recorded, and a clock area 23 formed from lands each extending along the recording tracks TN, projecting vertically from the hatched surface and having a magnetic layer provided thereon, and to which a fixed-period clock signal is to be recorded. The control information recording area AS also includes a unique area 24 formed as a concavity (will be referred to as “groove” hereunder).

In the magnetic disk designed as above, each of the plurality of recording tracks TN concentrically formed in the recording region 12 will be formed to include a data/information recording section formed from the plurality of partitioned data/information areas 20 isolated from each other by the control information recording area AS in each sector SN and surrounding the central hole 11, and the address information/ID information area 21, PES area 22 and clock area 23 disposed in a predetermined pattern in each control information recording area AS as an area to isolate the data/information recording sections from each other.

The magnetic layer formed in each partitioned data/information area 20 and those formed in each of the address information/ID information area 21, PES area 22 and clock area 23 will have a common signal recorded therein, that is, will be magnetized with the same signal or will have the same signal recorded therein, respectively.

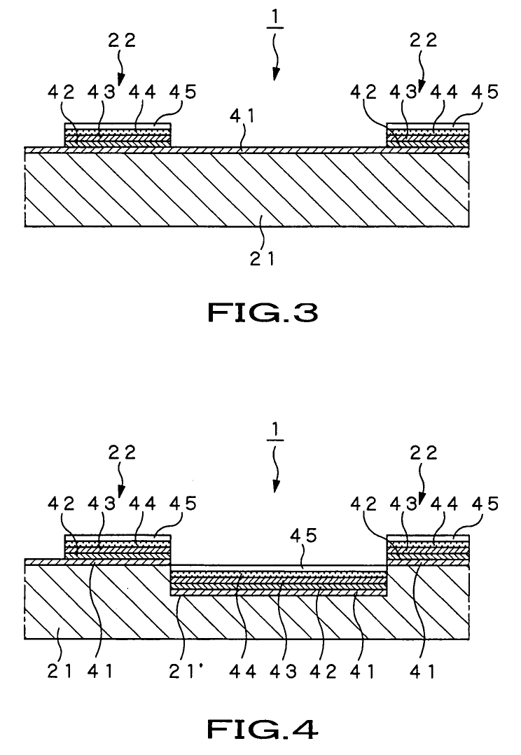

The substantial part, including the PES area 22, of the magnetic disk 1 produced by the aforementioned method will be explained in detail herebelow with reference to FIG. 3. As shown in FIG. 3, over the surface of the recording area 12 of the substrate 10, there is provided a nickel-phosphor layer 41 on which there are locally provided zones in each of which a chrome layer 42, magnetic layer 43, protective layer 44 formed from carbon etc. and a lubricant layer 45 are stacked on one another to thereby form the PES area 22.

The partitioned data/information area 20, address information/ID information area 21, PES area 22 and clock area 23 are formed by sequentially stacking the nickel-phosphor layer 41, chrome layer 42, magnetic layer 43, protective layer 44 and lubricant layer 45 on over, for example, a surfacial portion, which is to be the recording region 12, of the substrate 10 to form a lamination structure, then etching the lamination structure being masked correspondingly to shapes of portions where the partitioned data/information area 20, address information/ID information area 21, PES area 22 and clock area 23 are to be formed, removing the portions other than the masked portions for the chrome layer 42, magnetic layer 43, protective layer 44 and lubricant layer 45, and then unmasking the lamination structure.

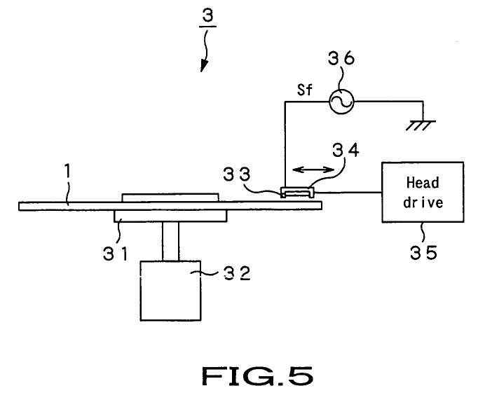

FIG. 4 shows in detail another example of the substantial part, including the PES area 22, of the magnetic disk 1. In this example, in a portion, which is to be the recording region 12, of the substrate 10, a concavity 21′ is formed around a location where the PES area 22 is to be formed, resulting in upward projection, in relation to the concavity 21′, of the portion where the PES area 22 is to be formed. In the portion, which is to be the recording region 12, of the substrate 10 and in which the concavity 21′ is formed, for example, a nickel-phosphor layer 41, chrome layer 42, magnetic layer 43, protective layer 44 formed from carbon etc. and lubricant layer 45 are stacked on one another to form, at the location where the PES area 22 is to be formed, a lamination structure including the nickel-phosphor layer 41, chrome layer 42, magnetic layer 43, protective layer 44 and lubricant layer 45. Thus, the PES area 22 is formed.

The partitioned data/information area 20, address information/ID information area 21, PES area 22 and clock area 23 are formed by etching a portion, which is to be the recording region 12, for example, of the substrate 10 with that portion being masked correspondingly to shapes of portions where the partitioned data/information area 20, address information/ID information area 21, PES area 22 and clock area 23 are to be formed, to form the concavity 21′ at a portion other than the masked portions, unmasking the lamination structure and then stacking the nickel-phosphor layer 41, chrome layer 42, magnetic layer 43, protective layer 44 and lubricant layer 45 on one another over the portion, which is to be the recording region 12, of the substrate 10 and in which the concavity 21′ is formed therein, to form a lamination structure.

Next, there will be explained with reference to FIG. 5 an example of the signal recording system for magnetizing each of the partitioned data/information area 20, address information/ID information area 21, PES area 22 and clock area 23, formed as having been described above, to have a pattern of N and S polarities alternating with each other, by recording a common signal, that is, the same signal, to the areas. It should be noted that the magnetization is generally called “magnetic disk initialization”.

In this example, the magnetic disk 1 has the partitioned data/information area 20, address information/ID information area 21, PES area 22, clock area 23 and unique area 24 provided in the portion, which is to be the recording region 12, of the substrate 10 is placed on a disk table 31, and rotated by a disk drive motor 32 at a predetermined velocity, for example, at 3600 rpm. A recording magnetic head 33 whose head width is about 1 mm and assembled in a head slider 34 is disposed opposite to a portion, which is to be the recording region 12, of the substrate 10 of the magnetic disk 1 thus being rotated. Being floated a little, for example, about 1μ, from the surface of the magnetic disk 1, the head slider 34 is moved by a head drive 35 radially of the magnetic disk 1, and the recording magnetic head 33 is supplied with a record signal Sf of a predetermined frequency from a signal source 36. It should be noted here that the frequency depends upon the length of a magnetic mark which is to be formed on the magnetic disk. As a result, the record signal Sf is recorded as the same signal to over each of the lands provided at the portion, which is to be the recording region 12, of the substrate 10 of the magnetic disk 1 (partitioned data/information area 20, address information/ID information area 21, PES area 22 and clock area 23).

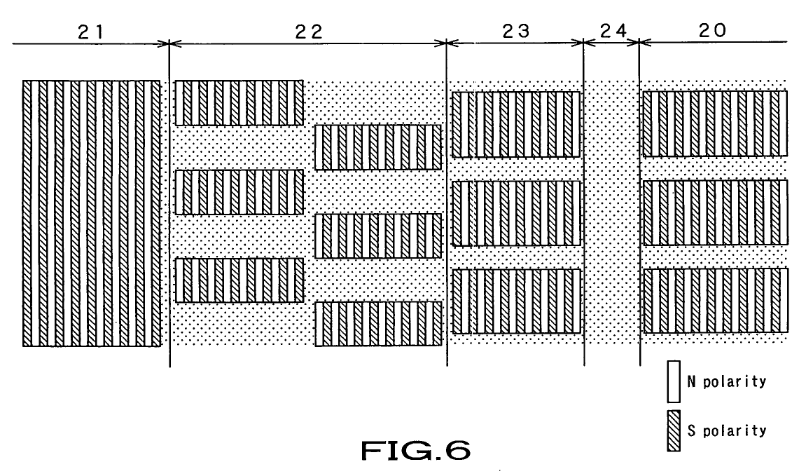

As above, each of the partitioned data/information area 20, address information/ID information area 21, PES area 22 and clock area 23, formed each as a convexity in the recording region 12 of the magnetic disk 1, is magnetized in a pattern of N and S polarities alternating with each other according to the record signal Sf (as shown in FIG. 6). It should be noted that for actually recording data to the magnetic disk 1 magnetized in the pattern of N and S polarities alternating with each other according to the record signal Sf, there will be required information (address information and ID information) with reference to which data is to be recorded.

Here will be explained how the address information/ID information is recorded to the magnetic disk 1 magnetized according to the record signal Sf in the pattern of N and S polarities alternating with each other, that is, the magnetic disk 1 after initialized.

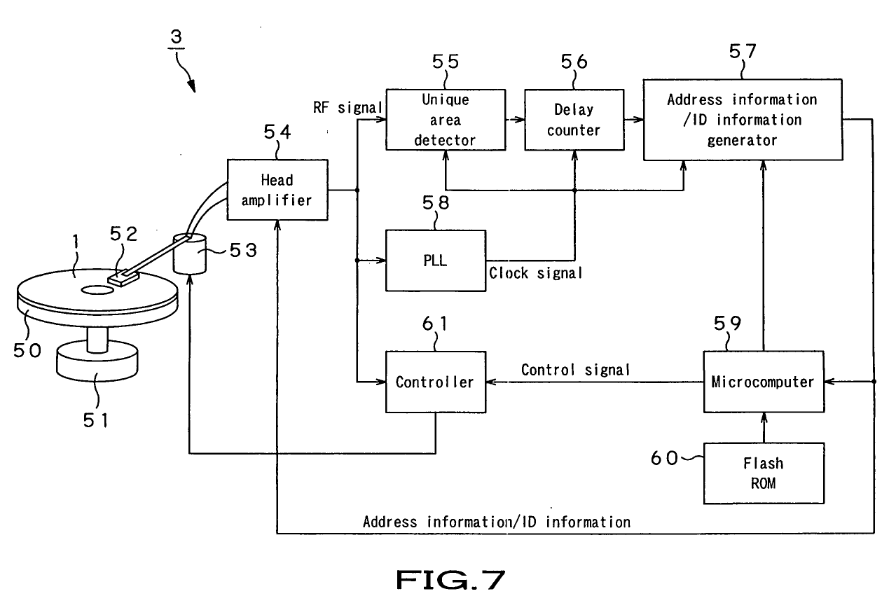

FIG. 7 is a schematic block diagram of a second example of the apparatus for recording address information/ID information to the magnetic disk. As shown in FIG. 7, the information recording apparatus, generally indicated with a reference numeral 3, includes a table 50 on which the magnetic disk 1 is to be placed, a disk rotation drive 51 to rotate the table 50, overwrite head (OWH) 52 to access the magnetic disk 1 and record and read data to and from the magnetic disk 1, a voice coil motor (VCM) 53 to drive the OWH 52, head amplifier 54 to amplify a signal supplied from the OWH 52, unique area detector 55 to detect the unique area 24 from a signal supplied from the head amplifier 54, delay counter 56 to give a delay of a fixed period to the signal when the unique area detector 55 has detected the unique area 24, address information/ID information generator 57 to generate unique address information/ID information, PLL (phase-locked loop) 58 to make PLL processing on the basis of a signal recorded in the clock area 23 and supply the PLL-processed signal to the unique area detector 55, delay counter 56 and address information/ID information generator 57, microcomputer 59 to control the address information/ID information generator 57, flash ROM 60 used to store data and a controller 61 to control the VCM 53 on the basis of signals supplied from the head amplifier 54 and microcomputer 59.

In the information recording apparatus 3, operations are made as will be described below. In step ST1, the OWH 52 accesses the initialized recording track TN on the magnetic disk 1 placed on the table 50. The clock area 23 and PES area 22 of the magnetic disk 1 have clock information and servo information recorded therein by the aforementioned initialization. The PLL 58 in the information recording apparatus 3 generates a clock signal on the basis of clock information recorded in the clock area 23. Servo information recorded in the PES area 22 is read based on the clock signal thus generated, and tracking of the OWH 52 is controlled based on the servo information thus read.

In step ST2, the information recording apparatus 3 detects the unique area 24. In the information recording apparatus 3, the unique area detector 55 detects the unique area 24 from a signal (RF signal) supplied from the head amplifier 54 on the base of the clock signal generated by the PLL 58. Since the unique area 24 is formed convex as above, so it is recognized as a no-signal area by the OWH 52. Also, when the unique area detector 55 has detected a no-signal area continuously for more than a predetermined time, it will recognize the area as the unique area 24.

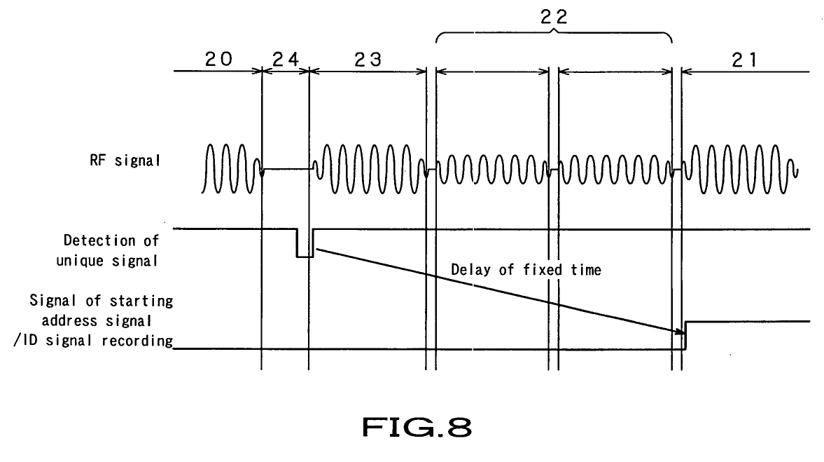

In step ST3, the information recording apparatus 3 has the address information/ID information generator 57 generate unique address information/ID information with a delay of a predetermined period (time) if the unique area 24 has been detected in the step ST2. It should be noted that the predetermined period (time) is a period (time) between the unique area 24 and address information/ID information area 21 (as shown in FIG. 8).

In step ST4, the information recording apparatus 3 records the address information/ID information to the address information/ID information area 21 after the generation of the address information/ID information is delayed the predetermined period (time) in step ST3.

The steps ST3 and ST4 will be described in further detail below. After detecting the unique area 24, the information recording apparatus 3 reads a servo signal recorded in the PES area 22 on the basis of the clock signal supplied from the PLL 58, controls tracking of the OWH 52 on the basis of the servo signal thus read, and records the address information/ID information whose generation has been delayed to the address information/ID information area 21 on the basis of the clock signal supplied from the PLL 58.

Also, the information recording apparatus 3 checks whether the address information/ID information has been recorded just after the apparatus 3 is started. With this checking, the information recording apparatus 3 judges whether the address information/ID information should be recorded to the address information/ID information area 21. The checking is effected as will be described below. In the information recording apparatus 3, the OWH 52 accesses the magnetic disk 1 on the table 50 and checks if a repetition signal is recorded in the partitioned data/information area 20 or address information/ID information area 21. In case it is determined that the repetition signal is recorded in the address information/ID information area 21, the OWH 52 will determine that the address information/ID information is not recorded in the address information/ID information area 21, and record the address information/ID information to the address information/ID information area 21.

Also, when recording the address information/ID information to the address information/ID information area 21, the information recording apparatus 3 registers, into the flash ROM 60, information that the address information/ID information has been recorded to the address information/ID information area 21. Referring to the information registered in the flash ROM 60, the information recording apparatus 3 checks if the address information/ID information has already been recorded in the address information/ID information area 21.

Next, timing of wiring the address information/ID information will be described.

The address information/ID information may be recorded to over the magnetic disk still in the production line before shipment of a hard disk drive in which the magnetic disk is assembled or each time a record start command is issued from a host computer when data is actually recorded to the magnetic disk after shipment of a hard disk having the magnetic disk assembled therein or after delivery from the production line.

In the latter case, it is judged whether the hard disk drive has ever been operated for recording data in response to the command. In case it is determined that the hard disk drive has been so operated, data is recorded only to the partitioned data/information area 20. On the contrary, if it is determined that the hard disk drive has not been so operated, the address information/ID information is recorded to the address information/ID information and data is recorded to the partitioned data/information area 20. It should be noted that the latter case can reduce the tact time more than the former case.

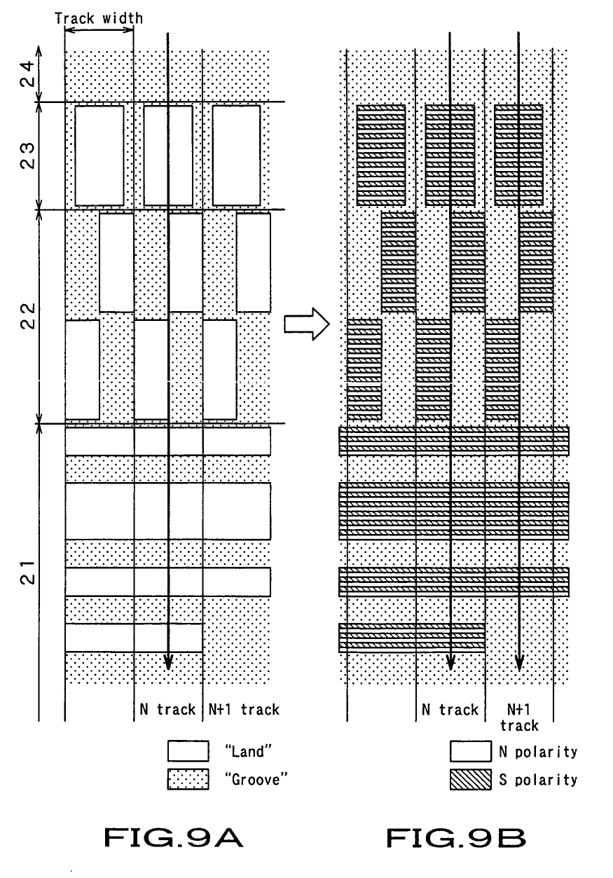

Also, the magnetic disk may be produced so that the address information/ID information can be detected depending upon whether there exists a repetition signal having the same frequency as that of the clock signal. That is, the magnetic disk is produced so that it is possible to detect, as “1”, a case in which the repetition signal exists for a predetermined time, for example, and as “0”, a case in which no repetition signal exists. More specifically, the address information/ID information area 21 is etched with the DTR technique on the basis of the address information/ID information to have a concavo-convex shape (as shown in FIG. 9A).

When the magnetic disk having the address information/ID information area 21 formed concavo-convex as above is initialized (as in FIG. 9B), no signal will be detected at the concave portion while a signal will be detected at the convex portion. A signal reproduced at this time serves as a repetition signal at the time of initialization for a length of time corresponding to the tangential-directional length of the convex portion.

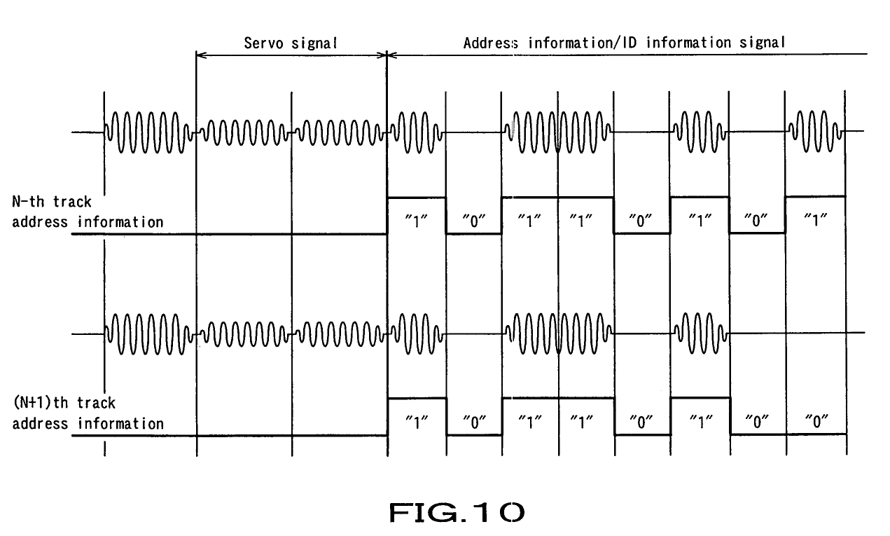

FIG. 10 illustrates a signal waveform obtained when the magnetic disk is played. The reproduced signal shown in FIG. 10 has the waveform of the RF signal read directly from the magnetic disk and the address information is the result of decoding a signal portion of the reproduced signal, recorded (formed in the concavo-convex form) in the address information/ID information area 21.

Also, the reproduced signal obtained from the address information/ID information area 21 of the magnetic disk after initialized (after having recorded thereto a repetition signal of a single frequency) depends upon the shape of the concavo-convexity formed in the address information/ID information area 21, and is detected depending upon existence or nonexistence of the repetition signal according to the concavo-convex form of the address information/ID information area 21.

Phase information and frequency information are synchronized with the repetition signal recorded in the address information/ID information area 21 on the basis of the clock information recorded in the clock area 23. A case in which the repetition signal appears for a period of a predetermined number of clocks, for example, of m clocks, is defined as “1”, while a case in which there appears no repetition signal for the period is defined as “0”. Thus, information can be padded with one bit at every m clocks.

In FIG. 10, a case in which 3 to 4 repetition signals appear for the above period is defined as “1”, while a case in which no repetition signal appears is defined as “0”.

As above, the present invention provides the magnetic disk 1 having formed concentrically in the recording region 12 thereof the recording tracks TN each including the partitioned data/information area 20, address information/ID information area 21, PES area 22 and clock area 23, each formed convex and magnetized in the pattern of N and S polarities alternating with each other, and also the convex unique area 24 formed between the partitioned data/information area 20 and clock area 23. In this magnetic disk 1, it is possible to detect the unique area 24, delay record of the address information/ID information, read the servo signal from the PES area 22 on the basis of the clock information read from the clock area 23 for the period of delay to control tracking of the head, and then record, based on the clock information, the address information/ID information whose recording has been delayed to the address information/ID information area 21 in a sector to which the detected unique area 24 also belongs.

Also, according to the present invention, the address information/ID information may be recorded to over the magnetic disk 1 yet in the production line before shipment of a hard disk drive having the magnetic disk 1 assembled therein or it may be recorded to each of the recording tracks TN each time a record start command is issued from a host computer when data is actually recorded to the magnetic disk 1 after shipment of a hard disk having the magnetic disk 1 assembled therein or after delivery from the production line. Especially, the latter case can reduce the tact time at the mass production of the magnetic disk 1.

Also, since according to the present invention, it is possible to approximate the format of a signal to be recorded to the magnetic disk 1 to that adopted in an IC installed in the existing magnetic disk playing system, the IC can easily be appropriated.

Also, according to the present invention, since the address information/ID information is recorded by etching or the like to (or formed on) each address information/ID information area on the basis of the address information/ID information in the process of producing the magnetic disk, no separate process is required for recording the address information/ID information, which will reduce the tact time.

It should be understood by those skilled in the art that various modifications, combinations, sub-combinations and alterations may occur depending on design requirements and other factors insofar as they are within the scope the appended claims or the equivalents thereof.

What is claimed is:

1. An information recording apparatus for recording address information/ID information to an address information/ID information area of a magnetic disk having formed, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the data area, clock area, servo area and address information/ID information area being formed convex and each recording track having a fixed-period control signal recorded therein, the apparatus comprising:
a detecting means for detecting a unique area;
a reading means for reading the fixed-period control signal recorded in the clock area;
an information generating means for generating unique address information/ID information; and
a recording means for recording, when the detecting means has detected a unique area, the unique address information/ID information generated by the information generating means to an address information/ID information area in a sector to which the detected unique area also belongs on the basis of the control signal read by the reading means.

2. The apparatus according to claim 1, further comprising:
a registering means for registering, when the unique address information/ID information has been recorded by the recording means to the address information/ID information area in a sector to which the unique area detected by the detecting means also belongs, information that the address information/ID information has already been recorded in the address information/ID information area;
a checking means for accessing the registering means when the recording means records the unique address information/ID information to an address information/ID information area, and checking if the address information/ID information has been recorded in the address information/ID information area; and
a controlling means for controlling, when the checking means has made sure that the address information/ID information has been recorded in the address information/information area, the recording means to cease the recording operation.

3. The apparatus according to claim 1, further comprising:
a detecting means for detecting that the recording means has recorded the unique address information/ID information into the address information/ID information areas in all the sectors included in one recording track; and
a track jumping means for jumping the head to another recording track on the basis of the result of detection from the detecting means.

4. An information recording method of recording address information/ID information to an address information/ID information area of a magnetic disk having formed therein, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the data area, clock area, servo area and address information/ID information area being formed convex and each recording track having a fixed-period control signal recorded therein, wherein
when a unique area has been detected, unique address information/ID information generated by an address information/ID information generating unit is recorded, with a delay of a fixed length of time, to an address information/ID information area in a sector to which the detected unique area also belongs on the basis of the fixed-period control signal recorded in the clock area.

5. A magnetic disk producing apparatus for producing a magnetic disk having formed therein, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the apparatus comprising:
an address information/ID information generating means for generating unique address information/ID information; and
an etching means for appropriately changing the shape of the address information/ID information area on the basis of address information/ID information generated by the address information/ID information generating means and etching the address information/ID information area.

6. A magnetic disk producing method of producing a magnetic disk having formed therein, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the method comprising the steps of:
recording unique address information/ID information to each address information/ID information area by appropriately changing the address information/ID information area on the basis of address information/ID information generated by an address information/ID information generating unit and etching the address information/ID information area.

7. A magnetic disk having formed therein, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, wherein
the data area, clock area, servo area and address information/ID information area are formed convex,
the address information/ID information area has formed thereon a convexity and/or concavity having an appropriate predetermined shape on the basis of address information/ID information generated by an address information/ID information generating unit for generating unique address information/ID information, and
each address information/ID information area has unique address information/ID information recorded therein.

8. An information recording apparatus for recording address information/ID information to an address information/ID information area of a magnetic disk having formed, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the data area, clock area, servo area and address information/ID information area being formed convex and each recording track having a fixed-period control signal recorded therein, the apparatus comprising:
a detector for detecting a unique area;
a reader for reading the fixed-period control signal recorded in the clock area;
an information generator for generating unique address information/ID information; and
a recorder for recording, when the detector has detected a unique area, the unique address information/ID information generated by the information generator to an address information/ID information area in a sector to which the detected unique area also belongs on the basis of the control signal read by the reader.

9. A magnetic disk producing apparatus for producing a magnetic disk having formed therein, in a direction from the central hole toward the outer radius, a plurality of circular recording tracks each including a plurality of sectors each including at least a data area where data is to be recorded, unique area where no data is to be recorded, clock area where a clock signal for detection of a phase signal is to be recorded, servo area where a servo signal is to be recorded and an address information/ID information area where address information/ID information is to be recorded, the apparatus comprising:
an address information/ID information generator for generating unique address information/ID information; and
an etching unit for appropriately changing the shape of the address information/ID information area on the basis of address information/ID information generated by the address information/ID information generator and etching the address information/ID information area.
